(19) United States
(12) Patent Application Publication
(10) Pub. No.: US 2013/0230696 A1
(43) Pub. Date: Sep. 5, 2013

(54) MATTE TEXTURED POWDER MONOCOAT COATING COMPOSITIONS

(71) Applicants: Susan Marie Sobek, Brunswick, OH (US); Susan Margaret Miller, North Royalton, OH (US)

(72) Inventors: Susan Marie Sobek, Brunswick, OH (US); Susan Margaret Miller, North Royalton, OH (US)

(73) Assignee: AKZO NOBEL COATINGS INTERNATIONAL B.V., Arnhem (NL)

(21) Appl. No.: 13/882,553

(22) PCT Filed: Nov. 2, 2011
(86) PCT No.: PCT/EP2011/069196

§ 371 Date: Apr. 30, 2013

Related U.S. Application Data
(60) Provisional application No. 61/409,347, filed on Nov. 2, 2010.

(30) Foreign Application Priority Data
Dec. 17, 2010 (EP) 10195682.9

(51) Int. Cl. C09D 7/12

(52) U.S. Cl. CPC C09D 7/12
USPC 428/147; 427/201; 524/91

(57) ABSTRACT

The present invention includes matte textured powder monocoat coating compositions that can be used to coat substrates, such as automobile bodies, and methods of coating such substrates. A powder coating composition may comprise a polyester resin, a UV light stabilizer, a matting agent, and a texturing additive, wherein the cured powder coating composition transmits less than about 0.1% of UV light at 290 nm and less than about 0.5% of UV light at 400 nm.

### BACKGROUND OF THE INVENTION

1. Field of the Invention

The present invention includes matte textured polyester powder monocoat coating compositions that can be used to coat substrates, such as automobile bodies, and methods of coating such substrates.

2. Summary of the Invention

The present invention includes matte textured polyester powder monocoat coating compositions that can be used to coat substrates, such as automobile bodies, and methods of coating such substrates with the matt textured polyester powder monocoat coating compositions.

One of the differences between automobile body coatings and exterior trim coatings is durability. For many OEM body coating specifications, the expectation is that the coating will maintain appearance and functional film integrity for 5+ years in Florida exposure. For high quality exterior trim coatings, the requirements are not as stringent for duration of exposure and functional film integrity after exposure. For example, some OEM body coating requirements call for gloss retention of at least about 90% after 1 year of Florida exposure, at least about 80% after 3 years of Florida exposure, and at least about 65% after 5 years of Florida exposure. For exterior trim coatings, the related durability requirements are at least about 80% gloss retention after 1 year of Florida exposure, at least about 50% after 3 years of Florida exposure, and no requirement after 5 years of Florida exposure.

In one embodiment of the invention, a powder coating composition comprises a polyester resin, a UV light stabilizer, a matting agent, and a texturing additive, wherein the cured powder coating composition transmits less than about 0.1% of UV light at 290 nm and less than about 0.5% of UV light at 400 nm. The invention also includes methods of coating a substrate comprising applying a powder coating composition to the substrate and curing the powder coating composition.

### DETAILED DESCRIPTION OF THE INVENTION

The present invention includes matte textured polyester powder monocoat coating compositions that can be used to coat substrates and methods of coating such substrates with the matte textured polyester powder monocoat coating compositions. The coated and cured powder coating compositions are matte, have a fine texture and satisfy automotive industry standards for UV transmission, chemical resistance and durability. In some embodiments, an electrocoat is applied to the substrate, and the powder coating compositions of the invention is applied over the electrocoat. Thus, the present invention also includes substrates coated with a dual-coat coating composition, the dual-coat coating composition having an electrocoat coated between the substrate and a powder coating composition of the present invention.

A powder coating composition of the present invention may comprise a polyester resin, a UV light stabilizer, a matting agent, and a texturing additive. Suitable polyester resins include, without limitation, a carboxyl functional polyester resin, a hydroxyl functional polyester resin, or a combination thereof.

In some embodiments, the polyester resin is present in an amount of from about 45 to about 75 wt % of the powder coating composition. For non-limiting example, the polyester resin may include a carboxyl functional polyester resin in an amount of from about 45 to about 75 wt % of the coating composition, a hydroxyl functional polyester resin in an amount of from about 45 to about 65 wt %, or a combination thereof.

In some embodiments, the powder coating composition includes one or more compounds that function as a curing agent or as a co-reacting resin. The curing agent or co-reacting resin may include, for non-limiting example, a hydroxyalkylamide, triglycidyl isocyanurate, a low epoxy equivalent weight (EEW) glycidyl methacrylate acrylic resin, such as a resin having an EEW of about 250 to about 400, a hydrogenated Bisphenol A epoxy resin, a uretedione-butanediol adduct, a polymeric aliphatic isocyanate, a multifunctional glycidyl ester, or a combination thereof. In some embodiments of the invention, the curing agent or co-reacting resin is present in an amount of from about 2 to about 35 wt % of the coating composition.

Suitable UV light stabilizers for use in the present invention include without limitation hydroxyphenyl benzotriazole, a hindered amine light stabilizer, an oxalanilide, a hydroxybenzophenone, a hydroxyphenyl-s-triazine, or a combination thereof. In some embodiments of the invention, the UV light stabilizer may be present in an amount of from about 0.1 to about 5 wt % of the powder coating composition, or from about 1 to about 3 wt % of the coating composition. The UV light stabilizer may be used to contribute to optimum weathering and UV transmission requirements.

In some embodiments of the invention, a powder coating composition having a UV light stabilizer satisfies UV transmission targets for automotive body coatings. For non-limiting example, a cured coating composition of the invention may transmit less than about 0.1% of UV light at 290 nm and less than about 0.5% of UV light at 400 nm.

The powder coating compositions of the invention can include a matting agent in some embodiments which may provide a matte appearance to the cured powder coating composition, such as when the cured coating composition exhibits a 60° gloss of less than about 10. The matting agent may include, without limitation, barium sulfate, magnesium silicate, silicon dioxide, alumino silicates, such as without limitation anhydrous sodium potassium alumino silicate, alkali alumino silicate ceramic microspheres, alumino silicate glass microspheres or flakes, polyolefin waxes in combination with the salt of an organic anion, polymeric wax additives, or a combination thereof. The matting agent may contribute to good dispersion and handling of the texturing additive and/or to contribute to restrict the flow of the coating composition. In some embodiments of the invention, the matting agent is present in an amount of from about 0.1 to about 40 wt % of the coating composition.

In some embodiments, the powder coating composition includes a texturing additive to provide a texture to the cured coating, such as when the cured coating composition exhibits a rough, rippled or sandy appearance, as opposed to a smooth or orange peel appearance. The texturing additive may include, for non-limiting example, polytetrafluoroethylene powder, PTFE/polyethylene wax mixtures, PTFE/talc mixtures, or a combination thereof. The polytetrafluoroethylene powder may be present in an amount of from about 0.05 to about 0.5 wt % of the coating composition, or from about 0.1 to about 0.2 wt % of the coating composition. In some embodiments, the polytetrafluoroethylene powder is a granular powder having a particle size of from about 5 to about 600 microns in average particle size, and alternatively from about 5 to about 25 microns in average particle size.

The powder coating compositions of the invention may be applied over an electrocoat to protect the electrocoat from UV degradation. The powder coating compositions may have a non-uniform thickness with hills and valleys, and the coated powder coating compositions can have a measured film thickness (when measuring the top of the hills) of about 35 to about 200 μm or about 50 to about 100 μm in some embodiments. In some coating compositions of the invention, the valley:hill thickness ratio is about 1:3 or from about 1:4 to about 1:2. A measured film thickness within the range of the present invention helps prevent UV light from penetrating through the valleys of the coating and reaching the underlying electrocoat. As a result, the thickness of the powder coating composition contributes to the stability of the underlying electrocoat. In addition, the UV light stabilizer that may be present in the powder coating composition also contributes to the stability of the underlying electrocoat, although the UV light stabilizer may have little or no benefit to the powder coating composition itself.

The powder coating compositions of the invention may also include additives, such as without limitation, pigments, degassing agents, antioxidants, fillers, flow aids, catalysts, or a combination thereof.

Pigments for use in powder coating compositions of the invention include, for non-limiting example, titanium dioxide, iron oxide (yellow, brown, red, black), carbon black and organic pigments. These pigments can be added in conventional amounts known to those in the art.

A degassing agent can be added to the composition to allow any volatile material present to escape from the film during baking. Benzoin is a degassing agent and when used in some embodiments can be present in amounts from about 0.05 to about 0.8 wt % of the coating composition.

Suitable antioxidants include, without limitation, phenolic, phosphite, phosphonite and lactone-type antioxidants, such as octadecyl-3-(3,5-Di-tert-butyl-4-hydroxyphenyl)-propionate and pentaerythritol tetrakis (3-(3,5-di-tert-butyl-4-hydroxyphenyl)-propionate, as well as combinations thereof. In some embodiments, the antioxidants are present in an amount of from about 1 to about 3 wt % of the powder coating composition.

The powder coating compositions of the invention may include one or more catalysts to accelerate the cure or otherwise catalyze the system to enhance the properties of the coating composition. Suitable catalysts include without limitation accelerated phenolic resins, alkyl ammonium salts, such as tetra butyl ammonium bromide, tetra butyl ammonium chloride, tetra butyl ammonium iodide and benzyltriethylammonium chloride, quaternary ammonium and phosphonium salts, phosphines, imidazoles, such as 2-methyl imidazole and 2-heptadecylimidazole, metal salts, 2,4-diamino-6 (2-methylimidazolyl-(1))-ethyl-s-triazine, tin salts, such as dibutyl tin dilaurate, ethyltriphenyl phosphonium acetate, triphenylphosphine, or a combination thereof. In some embodiments, the catalyst is present in an amount of from about 0.05 to about 1.5 wt % of the coating composition.

The powder coating compositions of the present invention are suitable for application to substrates, such as, without limitation, automotive bodies. However, it is also possible to apply the coating compositions to carbon, wood, glass, polymers, plastics and other substrates.

Application of the above described powder coating compositions can be accomplished by any known techniques, such as, without limitation, electrostatic spray or fluidized bed.

### EXAMPLES

The invention will be further described by reference to the following non-limiting examples. It should be understood that variations and modifications of these examples can be made by those skilled in the art without departing from the spirit and scope of the invention.

### Example 1

Coating Compositions A through C were prepared by ensuring that the ingredients listed were (1) Physically mixed under dry, non-molten conditions, i.e. in the solid state and without substantial melting of the components being mixed by use of a bladed mixer, whereby the combined ingredients were generally uniformly distributed throughout the resulting mixture. (2) Melt-mixed under conditions in which the mixture was generally in a liquid condition, although some components of the mixture could have been present as suspended or dispersed solids or could have been dissolved rather than molten. Melt mixing was accomplished by the use of a twin screw extruder at elevated temperature. (3) Cooled by passing through a pair of chill rolls. (4) Discharged into a mill where it was ground into small particles. (5) Sieved for further particle size classification.

The compositions of Coating Compositions A through C are shown in the table below. In this table the components are listed in parts by weight.

| Ingredients | Comp A | Comp B | Comp C |
|---|---|---|---|
| Carboxyl Polyester Resin A¹ | 26-30 | 26-30 | 26-30 |
| Carboxyl Polyester Resin B² | 26-30 | 26-30 | 26-30 |
| Hydroxyalkylamide | 3-4 | 3-4 | 3-4 |
| Hydroxyphenyl benzotriazole | | | 1-3 |
| Pentaerythritol tetrakis (3-(3,5- | 0.1-0.3 | 0.1-0.3 | 0.1-0.3 |
| di-tert-butyl-4- | | | |
| hydroxyphenyl)propionate) | | | |
| PTFE powder³ | 0.1-0.2 | 0.1-0.2 | 0.1-0.2 |
| Barium Sulfate⁴ | 0.2-1.0 | 0.2-1.0 | 0.2-1.0 |
| (BaSO₄) | | | |
| Aluminum Oxide⁵ | 0.03-0.07 | 0.03-0.07 | 0.03-0.07 |
| (Al₂O₃) | | | |
| Benzoin | 0.05-0.80 | 0.05-0.80 | 0.05-0.80 |
| Carbon Black | 1.5 | 3.0 | 1.5 |
| Magnesium Silicate⁶ | 3-8 | 3-8 | 3-8 |
| Aluminum Trihydrate⁷ | 25-36 | 25-36 | 25-36 |
| Silicon Dioxide⁸ | 0.1-0.3 | 0.1-0.3 | 0.1-0.3 |

¹Carboxyl Polyester Resin A with an acid number of 25, a Tg of 60° C.
²Carboxyl Polyester Resin B with an acid number of 55, a Tg of 61° C.
³PTFE powder with average particle size of 15 μm.
⁴Barium Sulfate with mean particle size of 2.5-3 μm.
⁵Aluminum Oxide with an average primary particle size of 13 nm.
⁶Magnesium Silicate with a median particle size of 2-3 μm.
⁷Aluminum Trihydrate with a median particle size of 10 μm.
⁸Silicon Dioxide with a median particle size of 10 μm.

Compositions A through C were coated, cured and evaluated for various properties. The evaluation results are shown in the following table.

| | Comp A | Comp B | Comp C |
|---|---|---|---|
| Film Build (μ) | 70 | 63 | 70 |
| ASTM D7081-05 | | | |
| Substrate | B1000 | B1000 | B1000 |
| Cure | 15/180 C. | 15/180 C. | 15/180 C. |
| 20°Gloss | 0.1 | 0.1 | 0.1 |
| ASTM D523-08 | | | |
| 60°Gloss | 1.6 | 1.2 | 2.5 |
| ASTM D523-08 | | | |
| Appearance | Fine | Fine | Fine |
| | texture | texture | texture |
| Gel Time (200° C.) | 45″ | 45″ | 50″ |
| Pill Flow (149° C.) | 15 mm | 12 mm | 15 mm |
| Direct Impact (in-lbs) | 160 | 160 | 160 |
| ASTM D2794-93 | | | |
| Reverse Impact (in- | 160 | 160 | 160 |
| lbs) | | | |
| ASTM D2794-93 | | | |
| Crosshatch Adhesion | 5B | 5B | 5B |
| ASTM D3359-09 | | | |
| Pencil Hardness | 3H | 4H | 4H |
| ASTM D3363-05 | | | |
| Tack Temperature (° C.) | 83 | 82 | 77 |
| Xylene (3 min spot | Pass | Pass | Pass |
| test) | | | |
| Ethanol (3 min spot | Pass | Pass | Pass |
| test) | | | |
| Isooctane/toluene | Pass | Pass | Pass |
| (24 hr spot test) | | | |
| UV Transmission | 1.46% | 1.16% | 0.01% |
| at 290 nm | | | |
| UV Transmission | 5.62% | 3.41% | 0.44% |
| at 400 nm | | | |

When viewing Composition A as the standard, the table above illustrates that the hydroxyphenyl benzotriazole light stabilizer in Composition C has a greater benefit on UV transmission compared to the increased amount of carbon black in Composition B.

### Example 2

Coating Compositions 1 through 16 were prepared using the technique described in Example 1. The compositions of Coating Compositions 1 through 16 is shown in the table below. In this table the components are listed in parts by weight.

| | YD300Q | YD300Q | YD301Q | YD301Q | YK300Q | YK300Q | YL300Q | YL300Q |
|---|---|---|---|---|---|---|---|---|
| | Ivory | Ivory | Beige | Beige | Turquoise | Turquoise | Trench Beige | Trench Beige |
| | no UVA | with UVA | no UVA | with UVA | no UVA | with UVA | no UVA | with UVA |
| Composition no. | 3 | 4 | 5 | 6 | 9 | 10 | 13 | 14 |
| Carboxyl Polyester Resin A¹ | 28.3 | 28.3 | 28.3 | 28.3 | 28.3 | 28.3 | 28.3 | 28.3 |
| Carboxyl Polyester Resin B² | 28.3 | 28.3 | 28.3 | 28.3 | 28.3 | 28.3 | 28.3 | 28.3 |
| Hydroxyalkylamide | 3.4 | 3.4 | 3.4 | 3.4 | 3.4 | 3.4 | 3.4 | 3.4 |
| Acrylate copolymer ³ | <0.1 | <0.1 | <0.1 | <0.1 | <0.1 | <0.1 | <0.1 | <0.1 |
| Hydroxyphenyl | — | 2.00 | — | 2.00 | — | 2.00 | — | 2.00 |
| benzotriazole | | | | | | | | |
| Pentaerythritol tetrakis (3- | 0.22 | 0.22 | 0.22 | 0.22 | 0.22 | 0.22 | 0.22 | 0.22 |
| (3,5-di-tert-butyl-4- | | | | | | | | |
| hydroxyphenyl)propionate) | | | | | | | | |
| PTFE powder⁴ | 0.14 | 0.14 | 0.14 | 0.14 | 0.14 | 0.14 | 0.14 | 0.14 |
| Barium Sulfate⁵ | 0.4 | 0.4 | 0.4 | 0.4 | 0.4 | 0.4 | 0.4 | 0.4 |
| Aluminum Oxide⁶ | <0.05 | <0.05 | <0.05 | <0.05 | <0.05 | <0.05 | <0.05 | <0.05 |
| Benzoin | <0.1 | <0.1 | <0.1 | <0.1 | <0.1 | <0.1 | <0.1 | <0.1 |
| Carbon Black | — | — | — | — | — | — | 0.15 | 0.15 |
| Magnesium Silicate⁷ | 4.6 | 4.6 | 4.6 | 4.6 | 4.6 | 2.6 | 4.6 | 4.6 |
| Aluminum Trihydrate⁸ | 2.0 | — | 2.0 | — | 9.3 | 9.3 | 10.8 | 8.8 |
| Silicon Dioxide⁹ | 0.18 | 0.18 | 0.18 | 0.18 | 0.19 | 0.18 | 0.19 | 0.18 |
| Titanium Dioxide | 32.0 | 32.0 | 29.6 | 29.6 | 21.6 | 21.6 | 22.0 | 22.0 |
| Sicopol Yellow L1100 | 0.18 | 0.18 | — | — | — | — | — | — |
| Zinc Ferrite Bayferrox 3950 | 0.13 | 0.13 | 1.33 | 1.33 | — | — | — | — |
| Heliogen Green L-9361 | — | — | — | — | 0.2 | 0.2 | — | — |
| Phthalo Green K-8605 | — | — | 0.01 | 0.01 | 2.0 | 2.0 | — | — |
| Phthalo Green 249-1282 | — | — | — | — | 1.2 | 1.2 | — | — |
| Yellow Iron Oxide YLO- | — | — | — | — | — | — | 1.2 | 1.2 |
| 2288-D | | | | | | | | |
| Irgazin Red DPP Red BO | — | — | — | — | — | — | — | — |
| Monastral Violet NRT-887-D | — | — | — | — | — | — | — | — |
| Phthalo Blue 248-0061 | — | — | — | — | — | — | — | — |
| Paliotol Yellow L-1970 D2K | — | — | — | — | — | — | — | — |
| Mixed Metal Oxide V-9140 | — | — | 1.2 | 1.2 | — | — | — | — |
| Hostaperm Yellow H3G | — | — | 0.20 | 0.20 | — | — | — | — |
| | 100 | 100 | 100 | 100 | 100 | 100 | 100 | 100 |

| | YG300Q | YG300Q | YJ300Q | YJ300Q | YF300Q | YF300Q | YN304G | YN304G |
|---|---|---|---|---|---|---|---|---|
| | Red | Red | Blue | Blue | Orange | Orange | Black | Black |
| | no UVA | with UVA | no UVA | with UVA | no UVA | with UVA | no UVA | with UVA |
| Composition no. | 15 | 16 | 7 | 8 | 11 | 12 | 1 | 2 |
| Carboxyl Polyester Resin A¹ | 28.3 | 28.3 | 28.3 | 28.3 | 28.3 | 28.3 | 28.2 | 28.2 |
| Carboxyl Polyester Resin B² | 28.3 | 28.3 | 28.3 | 28.3 | 28.3 | 28.3 | 28.2 | 28.2 |
| Hydroxyalkylamide | 3.4 | 3.4 | 3.4 | 3.4 | 3.4 | 3.4 | 3.4 | 3.4 |
| Acrylate copolymer ³ | <0.1 | <0.1 | <0.1 | <0.1 | <0.1 | <0.1 | <0.1 | <0.1 |
| Hydroxyphenyl | — | 2.00 | — | 2.00 | — | 2.00 | — | 2.00 |
| benzotriazole | | | | | | | | |
| Pentaerythritol tetrakis (3- | 0.22 | 0.22 | 0.22 | 0.22 | 0.22 | 0.22 | 0.23 | 0.23 |
| (3,5-di-tert-butyl-4- | | | | | | | | |
| hydroxyphenyl)propionate) | | | | | | | | |
| PTFE powder⁴ | 0.14 | 0.14 | 0.14 | 0.14 | 0.14 | 0.14 | 0.14 | 0.14 |
| Barium Sulfate⁵ | 0.4 | 0.4 | 0.4 | 0.4 | 0.4 | 0.4 | 0.4 | 0.4 |
| Aluminum Oxide⁶ | <0.05 | <0.05 | <0.05 | <0.05 | <0.05 | <0.05 | <0.05 | <0.05 |
| Benzoin | <0.1 | <0.1 | <0.1 | <0.1 | <0.1 | <0.1 | <0.1 | <0.1 |
| Carbon Black | — | — | 0.13 | 0.13 | — | — | 3.00 | 3.00 |
| Magnesium Silicate⁷ | 4.6 | 4.6 | 4.6 | 4.6 | 4.6 | 4.6 | 4.7 | 4.7 |
| Aluminum Trihydrate⁸ | 9.3 | 7.3 | 19.3 | 17.3 | — | — | 31.4 | 29.4 |
| Silicon Dioxide⁹ | 0.19 | 0.18 | 0.19 | 0.19 | 0.19 | 0.21 | 0.19 | 0.19 |
| Titanium Dioxide | — | — | 1.9 | 1.9 | 22.8 | 20.8 | — | — |
| Sicopol Yellow L1100 | — | — | — | — | — | — | — | — |
| Zinc Ferrite Bayferrox 3950 | — | — | — | — | — | — | — | — |
| Heliogen Green L-9361 | — | — | — | — | — | — | — | — |
| Phthalo Green K-8605 | — | — | — | — | — | — | — | — |
| Phthalo Green 249-1282 | — | — | — | — | — | — | — | — |
| Yellow Iron Oxide YLO- | — | — | — | — | — | — | — | — |
| 2288-D | | | | | | | | |
| Irgazin Red DPP Red BO | 22.7 | 22.7 | — | — | — | — | — | — |
| Monastral Violet NRT-887-D | 2.3 | 2.3 | — | — | — | — | — | — |
| Phthalo Blue 248-0061 | — | — | 13.0 | 13.0 | — | — | — | — |
| Paliotol Yellow L-1970 D2K | — | — | — | — | 4.0 | 4.0 | — | — |
| Mixed Metal Oxide V-9140 | — | — | — | — | 7.5 | 7.5 | — | — |
| Hostaperm Yellow H3G | — | — | — | — | — | — | — | — |
| | 100 | 100 | 100 | 100 | 100 | 100 | 100 | 100 |

¹Carboxyl Polyester Resin A with an acid number of 25, a Tg of 60° C.
²Carboxyl Polyester Resin B with an acid number of 55, a Tg of 61° C.
³ Levelling additive.
⁴PTFE powder with average particle size of 15 μm.
⁵Barium Sulfate with mean particle size of 2.5-3 μm.
⁶Aluminum Oxide with an average primary particle size of 13 nm.
⁷Magnesium Silicate with a median particle size of 2-3 μm.
⁸Aluminum Trihydrate with a median particle size of 10 μm.
⁹Silicon Dioxide with a median particle size of 10 μm.

The following table and graph illustrates SAE J1961 EMMAQUA® accelerated outdoor weathering testing data for Compositions 1-16 above.

| | | Initial | | After 280 MJ/m²EMMAQUA | | | | |
|---|---|---|---|---|---|---|---|---|
| | | Gloss | | (1 year Florida UV equivalent) | | | | |
| Composition | Master Product Code/ ID | 20° | 60° | 20° | 60° | ΔEColor | ΔChroma | ΔHue |
| 3 | YD300Q Ivory no UVA | 1 | 3 | 1 | 3 | 0.60 | −0.58 | −0.14 |
| 4 | YD300Q Ivory with UVA | 1 | 4 | 1 | 4 | 0.56 | −0.54 | −0.10 |
| 5 | YD301Q Beige no UVA | 1 | 2 | 1 | 2 | 1.46 | −1.28 | −0.70 |
| 6 | YD301Q Beige with UVA | 1 | 3 | 1 | 3 | 1.43 | −1.25 | −0.70 |
| 7 | YJ300Q Blue no UVA | 0 | 1 | 0 | 1 | 0.45 | 0.34 | 0.26 |
| 8 | YJ300Q Blue with UVA | 0 | 1 | 0 | 1 | 0.61 | 0.42 | 0.44 |
| 9 | YK300Q Turquoise no UVA | 0 | 2 | 0 | 2 | 0.59 | −0.53 | 0.21 |
| 10 | YK300Q Turquoise with UVA | 1 | 3 | 1 | 3 | 0.33 | −0.18 | 0.10 |
| 11 | YF300Q Orange no UVA | 1 | 3 | 1 | 3 | 5.99 | −5.94 | −0.77 |
| 12 | YF300Q Orange with UVA | 1 | 4 | 1 | 4 | 5.03 | −4.99 | −0.70 |
| 13 | YL300Q Beige Trench no UVA | 1 | 4 | 1 | 4 | 0.30 | −0.10 | 0.04 |
| 14 | YL300Q Beige Trench with UVA | 1 | 4 | 1 | 4 | 0.29 | −0.05 | 0.02 |
| 15 | YG300Q Red no UVA | 0 | 1 | 0 | 1 | 2.18 | 1.22 | −1.34 |
| 16 | YG300Q Red with UVA | 0 | 1 | 0 | 1 | 1.83 | 1.02 | −1.10 |
| 1 | YN304G Black no UVA | 0 | 2 | 0 | 2 | 0.08 | −0.06 | 0.00 |
| 2 | YN304G Black with UVA | 0 | 2 | 0 | 2 | 0.06 | −0.05 | 0.03 |

| | | After 560 MJ/m² EMMAQUA | | |
|---|---|---|---|---|
| | | (2 years Florida UV equivalent) | | |
| Composition | Master Product Code/ID | ΔEColor | ΔChroma | ΔHue |
| 3 | YD300Q Ivory no UVA | 0.59 | −0.58 | −0.08 |
| 4 | YD300Q Ivory with UVA | 0.63 | −0.62 | −0.02 |
| 5 | YD301Q Beige no UVA | 1.90 | −1.64 | −0.97 |
| 6 | YD301Q Beige with UVA | 1.88 | −1.61 | −0.98 |
| 7 | YJ300Q Blue no UVA | 0.80 | 0.46 | 0.64 |
| 8 | YJ300Q Blue with UVA | 1.49 | 0.76 | 1.26 |
| 9 | YK300Q Turquoise no UVA | 1.02 | −1.00 | 0.17 |
| 10 | YK300Q Turquoise with UVA | 0.67 | −0.65 | −0.04 |
| 11 | YF300Q Orange no UVA | 12.14 | −11.94 | −2.01 |
| 12 | YF300Q Orange with UVA | 10.01 | −9.86 | −1.71 |
| 13 | YL300Q Beige Trench no UVA | 0.14 | −0.06 | 0.02 |
| 14 | YL300Q Beige Trench with UVA | 0.15 | 0.01 | 0.03 |
| 15 | YG300Q Red no UVA | 4.11 | 1.69 | −2.89 |
| 16 | YG300Q Red with UVA | 4.37 | 2.02 | −2.90 |
| 1 | YN304G Black no UVA | 0.3 | −0.28 | 0.07 |
| 2 | YN304G Black with UVA | 0.35 | −0.31 | 0.09 |

As shown in Example 2, the presence of a UV light stabilizer has little effect on the color retention of the powder coating composition. However, as noted above, the UV light stabilizer may contribute to the stability of the underlying electrocoat.

1. A dual-coat powder coating composition comprising:
an electrocoat; and
a matte textured powder coating composition comprising:
a) a polyester resin;
b) a UV light stabilizer;
c) a matting agent; and
d) a texturing additive,
wherein the polyester resin includes a carboxyl functional resin, a hydroxyl functional resin, or a combination thereof.

2. The dual-coat powder coating composition of claim I, wherein the polyester resin is present in an amount from about 45 weight % to about 75 weight % of the powder coating composition.

3. The dual-coat powder coating composition of claim I, further comprising a curing agent or a co-reacting resin, wherein the curing agent or co-reacting resin comprises a hydroxyalkylamide, a triglycidyl isocyanurate, a glycidyl methacrylate acrylic resin, a hydrogenated Bisphenol A epoxy resin, a uretedione-butanediol adduct, a polymeric aliphatic isocyanate, a multifunctional glycidyl ester, or a combination thereof.

4. The dual-coat powder coating composition of claim 1, wherein the UV light stabilizer comprises hydroxyphenyl benzotriazole, a hindered amine light stabilizer, an oxalanitide, hydroxybenzophenone, a hydroxyphenyl-s-triazine, or a combination thereof.

5. The dual-coat powder coating composition of claim 1, wherein the matting agent comprises barium sulfate, magnesium silicate, silicon dioxide, altimino silicates, alkali alumina silicate ceramic microspheres, alumino silicate glass microspheres or flakes, polyolefin waxes in combination with the salt of an organic anion, polymeric wax additives, or a combination thereof.

6. The dual-coat powder coating composition of claim 1, wherein the texturing additive comprises polytetrafluoroethylene powder, PTFE/polyethylene wax mixtures, PTFE/talc mixtures, or a combination thereof.

7. The dual-coat powder composition of claim 1, further comprising a pigment, a degassing agent, an antioxidant, a filler, a flow aid, a catalyst, or a combination thereof.

8. A method of coating a substrate comprising applying the dual-coat powder coating composition of claim 1 to the substrate and curing the dual-coat powder coating composition.

9. The method of claim 8, wherein the substrate is an automobile body.

10. The method of claim 8, wherein the electrocoat is coated between the substrate and the a matte textured powder coating composition.

11. An automobile body coated with the dual-coat powder coating composition of claim 1.

12. The automobile body of claim 11, wherein the electrocoat is coated between the automobile body and the matte textured powder coating composition.

13. A substrate coated with a dual-coat coating composition, the dual-coat coating composition comprising an electrocoat coated between the substrate and the matte textured powder coating composition of claim 1.

14. The dual-coat powder coating composition of claim 1, wherein the cured matte textured powder coating composition exhibits a 60° gloss of less than about 10.

15. The dual-coat powder coating composition of claim 1 wherein the valley:hill thickness ratio is from about 1:4 to about 1:2.

16. The substrate of claim 13 wherein the coated matte textured powder coating composition has a measured film thickness of about 35 to about 200 μm.

17. The dual-coat powder coating composition of claim 1 wherein the cured powder coating composition transmits less than about 0.1% of UV light at 290 nm and less than about 0.5% of UV light at 400 nm.

18. The dual-coat powder coating composition of claim 1 wherein the polyester resin is a carboxyl functional resin.

19. The dual-coat powder coating composition of claim 3 wherein the curing agent and/or co-reacting resin is present in an amount from about 2 to about 35 weight % of the powder coating composition.

20. The dual-coat powder coating composition of claim I wherein the UV light stabilizer is present in an amount from about 0.1 weight % to about 5 weight % of the powder coating composition.

21. The dual-coat powder coating composition of claim I wherein the matting agent is present in an amount from about 0.1 weight % to about 40 weight % of the powder coating composition.

22. A matte textured powder coating composition comprising:
a) a polyester resin;
b) a UV light stabilizer;
c) a matting agent; and
d) a texturing additive,
wherein the polyester resin includes a carboxyl functional resin, a hydroxyl functional resin, or a combination thereof and wherein the cured powder coating composition transmits less than about 0.1% of UV light at 290 nm and less than about 0.5% of UV light at 400 nm.
